(19) United States
(12) Patent Application Publication
(10) Pub. No.: US 2018/0356233 A1
(43) Pub. Date: Dec. 13, 2018

(54) INTELLIGENT NAVIGATION ASSISTANCE DEVICE

(71) Applicant: Boutros Baqain, Pacifica, CA (US)

(72) Inventor: Boutros Baqain, Pacifica, CA (US)

(21) Appl. No.: 15/621,907

(22) Filed: Jun. 13, 2017

(51) Int. Cl. G01C 21/04; A61H 3/06; H04M 3/493; A61G 5/10

(52) U.S. Cl. CPC G01C 21/04; A61H 3/061; G10L 15/005; A61G 5/10; A61H 2003/063; H04M 3/4936

(57) ABSTRACT

An intelligent navigation assistance device including a mobility device (e.g., a walking staff, a walker, a wheelchair) configured with input component(s) to receive user input, environment component(s) to detect objects or obstacles in the surrounding environment, panic component(s) to detect emergency situations or conditions, local computing device(s) to process information and facilitate communication/control with/of mobile computing device(s) (including access to resources of the mobile computing device, e.g., GPS receiver, route mapping applications, telecommunications capabilities), and feedback component(s) to convey information to users via one or more prompt to the user.

### TECHNICAL FIELD

The present disclosure relates generally to personal navigation technologies, and more particularly some embodiments relate to navigation assistance devices for enabling persons with physical limitations to more safely and effectively navigate their travels, and in some instances to obtain emergency assistance.

### BACKGROUND OF THE DISCLOSURE

Physically impaired persons face many difficulties in navigating from one location to another, both when moving about on their own and also when attempting to use transportation (e.g., buses, trains, shuttles, etc.).

Visually impaired persons often find it difficult to: (i) detect objects or obstacles in the their path (e.g., rocks, puddles, curbs, pot holes, stairs, escalators, etc.), and (ii) perceive approaching objects that may strike them if their position or posture is not adjusted (e.g., an unwary cyclist proceeding toward the person, a stray ball rolling down a hill toward the person, etc.).

Visually impaired persons also often find it difficult to utilize transportation resources. In particular, some visually impaired persons find it difficult to: (i) navigate to nearest pickup locations to board a transportation vehicle (e.g., bus, train, and shuttle pickup spots), (ii) appreciate their current location as the transportation vehicle moves along its route, (iii) understand when the transportation vehicle approaches a drop-off location where the person desires to exit, and (iv) reorient themselves upon exiting the transportation vehicle (e.g., understanding which direction they are facing when they get out of the bus). In addition to the foregoing, a physically disabled person (e.g., a paraplegic individual) may find it difficult to: (i) navigate to nearest pickup locations that have wheelchair access, or to identify transportation vehicles equipped with necessary wheelchair accommodations.

Physically impaired individuals also often find it difficult to reroute or reorient themselves in order to arrive at their desired destination when their travel plans are interrupted or obstructed (e.g., the person receives a call notifying them they need to be in another location, their original route is obstructed by construction occurring along the walking path, their original route is obstructed by flood water is running over the path, and the like) or they become confused as to their location (e.g., a person becomes disoriented as to the direction they are facing or their geographic location relative to their destination or path of travel).

Moreover, when physically impaired persons find themselves in situations where they need assistance (in an emergency situation, an injury situation, or otherwise), it can be difficult for them to summon assistance in the manner they need it most. For instance, visually impaired persons often find it difficult to: (i) locate where help may be obtained (e.g., health clinics, police stations, lost and found kiosks, etc.), (ii) get ahold of emergency response agencies or other responders when they need assistance to come to them (e.g., calling family, friends, or an ambulance), and (iii) describe their location to those who would otherwise attempt to assist them. Similarly, impaired individuals who fall down and injure themselves may find it difficult to: (i) maneuver themselves to be able to reach a communications device to call for help, (ii) get ahold of emergency response agencies or other responders when they need assistance to come to them (e.g., calling family, friends, or an ambulance), and (iii) describe their location to those who would otherwise attempt to assist them.

Conventional navigation aids for persons with physical limitations do not provide adequate remedies for the foregoing problems. Neither walking staffs for the blind, nor walkers or canes for the elderly, nor wheelchairs for the crippled, nor any other navigation tools on the market provide adequate solutions to the foregoing problems. The present disclosure is therefore directed toward systems and methods that improve upon conventional navigation aids, and which enable persons with physical limitations to more safely and effectively navigate their travels, and in some instances to obtain emergency assistance.

### SUMMARY OF THE DISCLOSURE

According to an embodiment of the disclosed technology an intelligent navigation assistance device may include: a mobility device (e.g., a walking staff, a walker, a wheelchair, etc.); an input component; a feedback component; a processor; a memory; a communications interface; a non-transitory computer readable medium storing machine readable instructions that, when executed by the processor, cause the intelligent navigation assistance device to: transmit one or more signals to a mobile computing device responsive to user input, the one or more signals configured to control one or more operations of one or more resources of the mobile computing device, the one or more resources including at least: a GPS receiver and a route mapping application; receive one or more signals from the mobile computing device, the one or more signals providing navigation information based on information obtained from one or more of the GPS receiver and the route mapping application; and cause the feedback components to provide one or more prompts to a user based on the navigation information received from the mobile computing device.

Some embodiments of the disclosed technology further include: an environment component comprising one or more of an infrared sensor and a ultrasonic sensor adapted to detect the presence of physical objects in a surrounding environment; wherein the non-transitory computer readable medium stores machine readable instructions that, when executed by the processor, causes the intelligent navigation assistance device to: activate the feedback component responsive to the environment component detecting a physical object in the surrounding environment.

Some embodiments of the disclosed technology further include: an panic component comprising one or more of an accelerometer and a gyroscope adapted to detect a condition indicating the user has fallen; wherein the non-transitory computer readable medium stores machine readable instructions that, when executed by the processor, causes the intelligent navigation assistance device to: generate a panic alert responsive to the panic component detecting a condition indicating the user has fallen.

Some embodiments of the disclosed technology include: an panic component comprising a timer circuit and one or more of an accelerometer and a gyroscope adapted to detect a condition indicating the user has fallen; wherein the non-transitory computer readable medium stores machine readable instructions that, when executed by the processor, causes the intelligent navigation assistance device to: generate a panic alert responsive to the timer circuit detecting that a predetermined amount of time has elapsed after the panic component detects a condition indicating the user has fallen.

In some embodiments, the communications interface comprises one or more of a wireless transmitter (e.g., an RF transmitter) and a wireless receiver (e.g., an RF receiver). In some embodiments, the communications interface comprises a wireless transceiver (e.g., an RF transceiver).

In some embodiments, the navigation information includes one or more of geographic location information, route information, walking information, direction information, transportation information, and establishment information.

In some embodiments, the input component include one or more of a push button, a capacitive touch sensor, a microphone, and a throw switch.

In some embodiments, the one or more signals transmitted to the mobile computing device are generated responsive to actuation of the input component. In some embodiments, the input component is a microphone configured to transduce verbal sounds.

In some embodiments, the non-transitory computer readable medium stores machine readable instructions that, when executed by the processor, causes the intelligent navigation assistance device to: determine one or more of an object type, an obstacle type, a proximity to a portion of an object, a proximity to a portion of an obstacle, a relative location of an object, a relative location of an obstacle.

Some embodiments of the disclosed technology further include: a battery charging circuit adapted to receive energy from a power source, and utilize the received energy to charge a battery of the intelligent navigation device. In some embodiments the battery charging circuit can facilitate inductive charging (e.g., receive energy from a magnetic charging source), solar charging (e.g., receive energy from the sun via a photovoltaic module), direct current charging, alternating current charging, or any other charging mechanism, including any known in the art.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

Some of the figures included herein illustrate various embodiments of the disclosed technology from different viewing angles. Although the accompanying descriptive text may refer to such views as “top,” “bottom” or “side” views, such references are merely descriptive and do not imply or require that the disclosed technology be implemented or used in a particular spatial orientation unless explicitly stated otherwise.

FIG. 1 illustrates an example intelligent navigation assistance device in accordance with one or more embodiments of the present disclosure.

FIG. 2A illustrates a magnified view of a heel portion of the an example intelligent navigation assistance device shown in FIG. 1, in accordance with one or more embodiments of the present disclosure.

FIG. 2B illustrates a magnified view of a handle portion of the example intelligent navigation assistance device shown in FIG. 1, in accordance with one or more embodiments of the present disclosure.

FIG. 3 illustrates an environment within which an example intelligent navigation assistance device of FIG. 1 may operate, in accordance with one or more embodiments.

FIG. 4 illustrates a mobile computing device including or having access to one or more on-board or off-board resources that may be utilized by an intelligent navigation assistance device of the present disclosure, in accordance with one or more embodiments.

FIG. 5 illustrates a visually impaired person using an example intelligent navigation assistance device in accordance with one or more embodiments of the present disclosure.

FIG. 6 illustrates another example intelligent navigation assistance device in accordance with one or more embodiments of the present disclosure.

FIG. 7 illustrates an environment within which an example intelligent navigation assistance device of FIG. 6 may operate, in accordance with one or more embodiments.

FIG. 8 illustrates an elderly person using the example intelligent navigation assistance device of FIG. 6 in accordance with one or more embodiments of the present disclosure.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

Embodiments of the technology disclosed herein relate to intelligent navigation assistance technologies for enabling persons with physical limitations (e.g., visually impaired) to more safely and effectively navigate from one location to another, and in come embodiments to summon assistance. The intelligent navigation assistance technologies disclosed herein enable physically impaired users to enhance their ability to navigate a course of travel by efficiently utilizing one or more resources of a mobile computing device with which an intelligent navigation assistance device (hereafter “INAD”) may be paired. As disclosed herein, such systems and devices may intelligently assist persons with physical limitations to more safely and effectively navigate their course of travel, and in some instances to communicate with third parties as necessary. Example mobile computing device resources may include GPS resources (e.g., GPS modules), mapping resources (e.g., mapping applications such as Google Maps™), voice and text communications resources (RF modules, calling/texting applications, other resources), emergency alert resources (e.g., 9-1-1 dialing, Red Panic Button application, Bull Horns Panic Button application, or any other resource). As disclosed herein, an INAD in accordance with embodiments of the present disclosure may be paired with a mobile computing device in an arrangement that enables the user to control (e.g., operate, inform, facilitate, interact with, command, instruct) one or more resources of the mobile computing device, and in some instances to transmit information to or receive information from the mobile computing device. Some embodiments of the present disclosure are further configured to process, generate, or relay information to the user or to a third party, based in whole or in part on information received from the user, generated by the INAD, received from the mobile computing device, or any combination of the foregoing.

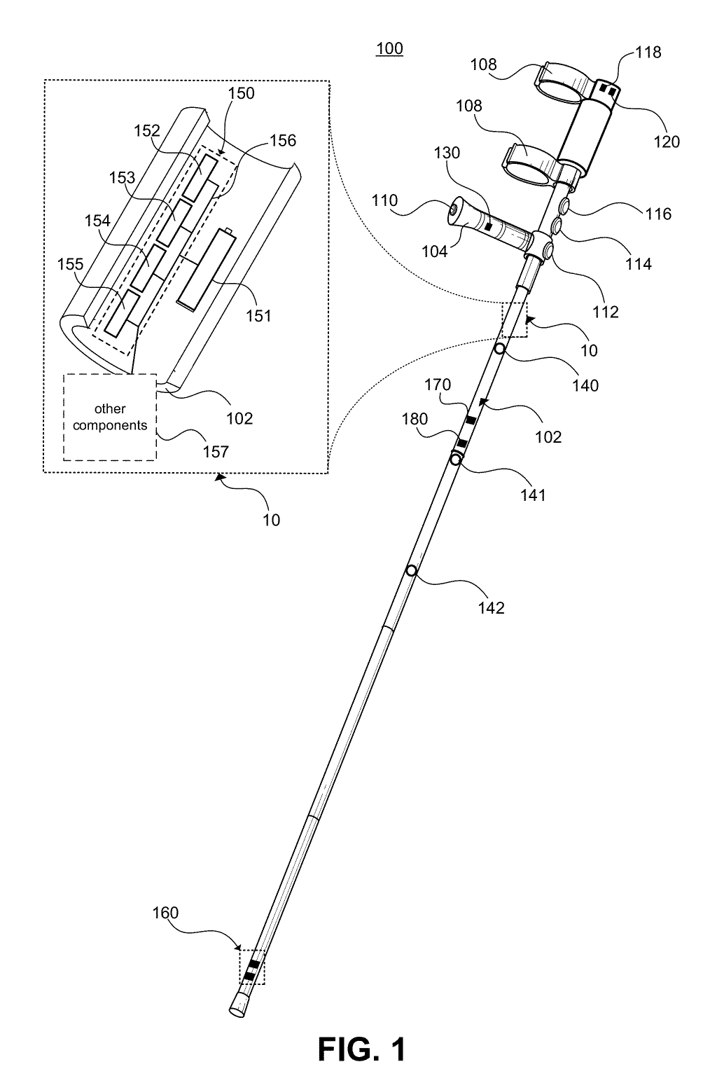

FIG. 1 illustrates an INAD in accordance with one or more embodiments of the present disclosure. Although INADs of the present disclosure may come in various structural forms, the INAD depicted in FIG. 1 takes the form of a walking staff for visually impaired persons (sometimes referred to herein as an intelligent walking staff). As shown, the INAD 100 may include one or more of a walking staff 102, user input components (e.g., input components 110-118), environment sensor components 160, panic sensor components 170, feedback components (e.g., feedback components 120,130), visibility sensor components 180, LEDs (e.g., LEDs 140-142), and a local computing device 150 (sometimes referred to herein as a first computing device) including a processing engine 152, a communications interface 153, a memory 154, and a non-transitory machine readable medium 155 storing machine readable instructions that, when executed, effectuate one or more of the features discussed herein. As shown, first computing device 150 (including its sub-elements) may be coupled with any other components 157 of the INAD 100, including any one or more of the aforementioned components (e.g., input components, environment sensor components, panic sensor components, feedback components) or any other elements of INAD 100 (e.g., a power supply such as battery 151). Such coupling may be established via any wired, wireless, or hardware interface.

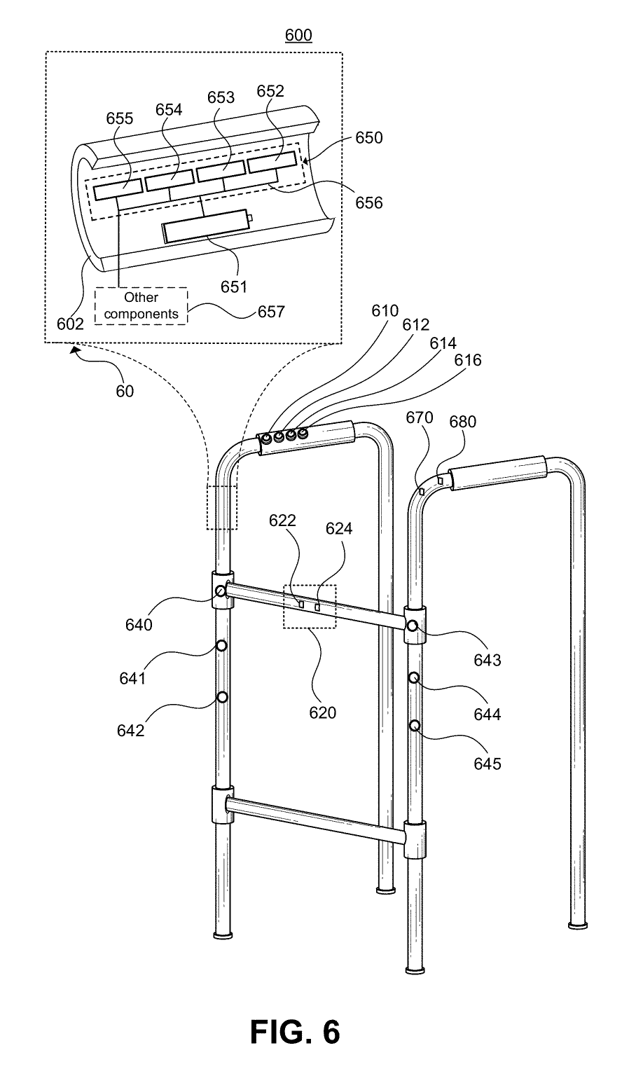

As shown, in some embodiments INAD 100 may include a walking staff 102. Walking staff 102 may in some embodiments include an elongate, partially hollow walking staff configured for use by the visually impaired. Although such a walking staff 102 for the visually impaired is depicted in FIG. 1, it should be understood that any walking staff or mobility support device may be employed, and that the present disclosure is not intended to be limited by the depicted embodiment. In particular, walking staff 102 may take any physical form desired (e.g., a cane, a crutch, a walker (depicted in FIG. 6), etc.) or incorporate any desired structural features (e.g., telescoping capability, with or without a handle or wrist support, etc.).

As shown, in some embodiments INAD 100 may include one or more input components. Input components of the present disclosure may in some embodiments include pushbuttons (e.g., push buttons 110-116, switches, etc.), sensors (e.g., microphone 118, touch sensors, etc.), or any other devices or circuits that a user may actuate or trigger to provide input. As described herein, user input provided through the one or more input components may cause or initiate operations that effectuate one or more features of the present disclosure. Though FIG. 1 depicts only push button and microphone type input components, any other type or number of input components desired may be employed. For example, in addition to or in place of push button 110, INAD 100 may be equipped with one or more input components in the form of: a capacitive touch sensor, a throw switch, a slider switch, a dial, a joystick, a trigger, or any other actuator or sensory device configured to manipulate an electrical signal when triggered.

As described in further detail herein, user's may operate one or more input components of an INAD in a predefined manner to provide input or otherwise control operation of the INAD. Such input may be provided via input components in various ways, such as by a pattern of button presses that correspond to a particular command, an audible voice instruction provided via microphone 118 that corresponds to a particular command, a toggle of a throw switch that corresponds to a particular mode or condition desired (causing the execution of an instruction that implements the particular mode or condition), a tap-and-hold contact pattern on a capacitive touch sensor where the tap and hold pattern corresponds to a particular command, etc. One of ordinary skill in the art will appreciate that any type or number of input components may be implemented with INADs of the present disclosure, and any actuation pattern or combination may be preset to correspond to a command that implements or initiates any feature or capability discussed herein. Furthermore, signal transmissions between the INAD 100 and other components or computing devices (as described in more detailherein) may be generated or transmitted based upon input from the user as provided via one or more input components (e.g., input components 110-118) of INAD 100.

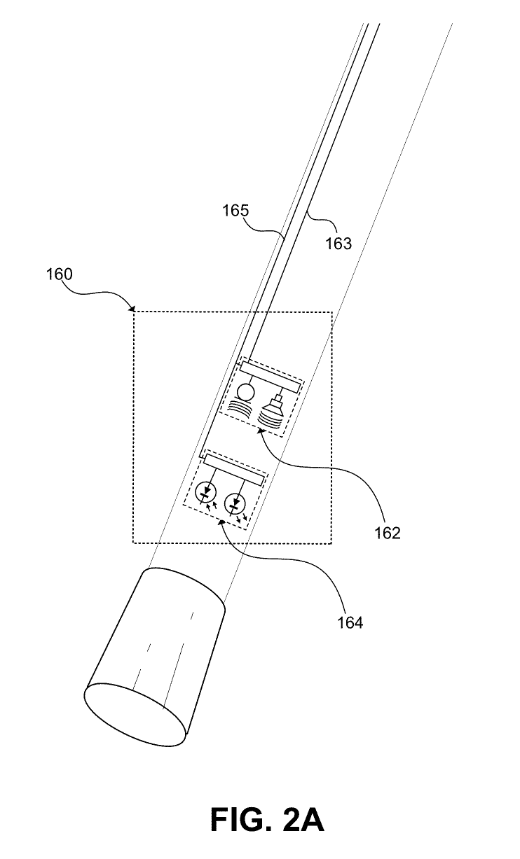

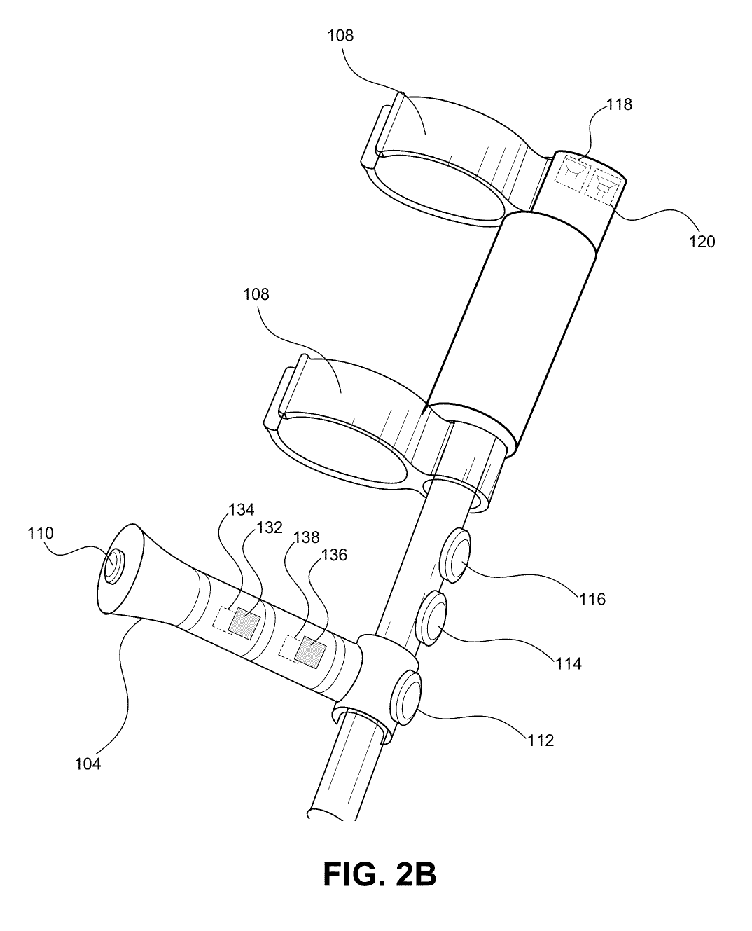

As further shown in FIG. 1, in some embodiments INAD 100 may include one or more environment sensor components 160. Environment sensor components 160 of the present disclosure may include any sensors and related circuitry provided to detect objects or obstacles in all or a portion of a surrounding environment. Examples of environment sensors that may make up all or part of environment sensor component 160 may be seen in FIG. 2A.

FIG. 2A illustrates a magnified view of a heel portion of the walking staff 102 styled INAD 100 shown in FIG. 1, in accordance with one or more embodiments of the present disclosure. As shown, one or more embodiments of INAD 100 of the present disclosure may include one or more environment sensors capable of detecting objects or obstacles in all or a portion of the environment surrounding the INAD 100. For instance, such objects or obstacles detectable by environment sensors may include, a step, a curb, a pot hole, a set of stairs, an escalator, a slope, a hill, a puddle, a ball, or any other object or obstacle. Environment sensors may include, for example, one or more of an infrared sensor 164, an ultrasonic sensor 162, or any other sensor (and related circuitry) configured to detect objects, obstacles, or other characteristics in a surrounding environment. Although FIG. 2A only depicts a single ultrasonic sensor 162 and a single infrared sensor 164, it should be understood that any type or number of environment sensors may be employed. In some embodiments, multiple environment sensors may be used to enhance the accuracy or capabilities of the environment sensing features of the INADs of the present disclosure.

Infrared sensor 164 may be configured to sense characteristics of the surrounding environment. By way of example, infrared sensor 164 may be configured to measure distance(s) to objects or obstacles (if any) within a surrounding environment (such as within a predefined zone around the sensor that captures at least a portion of the users imminent path) by emitting and/or detecting infrared radiation reflected back to the sensor within that zone. Infrared sensor 164 may measure heat emitted by an object or obstacle in a surrounding environment, may measure movement of an object or obstacle in a surrounding environment, or both. By way of another example, ultrasonic sensor 162 may measure distance(s) to objects or obstacles (if any) within a surrounding environment (such as within a predefined zone around the sensor that captures at least a portion of the users imminent path) by emitting and/or detecting ultrasonic sound waves within that zone. Any one or more environment sensors may be operated alone or together (periodically or on command), either while the user stands still or as the user moves along their path of travel. In some embodiments environment sensors and may be used to detect whether or not some irregular object or obstacle is in the user's imminent path (e.g., within the next 5 feet of the path of travel).

In some embodiments, the one or more environment sensors may be operated iteratively such that the first computing device may, based on signals generated by the environment sensors, make a determination as to the type of object or obstacle in the user's path. This may be performed by taking multiple measurements from a single environment sensor, e.g., taking measurement every ‘x’ milliseconds. Using this approach the INAD 100 may effectively scan the surrounding environment with a single sensor such that the first computing device 150 can make a determination about the type of object or obstacle in the user's imminent path based on a plurality of the measurements taken.

Alternatively or additionally, multiple sensors may be operated (periodically or on command) in a synchronized or coordinated manner as the user moves along a path of travel. In some instances the first computing device can make a determination about the type of object or obstacle in the user's imminent path based on a plurality of measurements taken by such sensors. For example, a series of ultrasonic sensors may be mounted along the length of the walking staff 102 such that the ultrasonic sensors are at different heights when the walking staff 201 is in use. The first computing device 150 may execute machine readable instructions (vi its processing engine) to cause the ultrasonic sensors to take measurements in coordination with one another, then use the measurements taken to determine a profile of one or more objects in the user's path and compare it to a profile template library to determine the type of obstacle in the user's path.

For instance, the measurements taken may correspond to a uniform step profile, the first computing device determining (based on matching the detected profile with a similar profile in the profile template library) that the type of obstacle the user is headed toward is a “staircase”. In another example, the measurements taken may correspond to a sharp increase in slope, the first computing device determining (based on matching the detected profile with a similar profile in the profile template library) that the type of obstacle the user is headed toward is a “hill”. In another example, iterative measurements taken may correspond to a step profile that is changing with time in a vertical direction, the first computing device determining (based on matching the detected profile with a similar profile in the profile template library) that the type of obstacle the user is headed toward is a “an upward escalator in operation”). Any object or obstacle detection and recognition may be implemented using any type or number of environment sensors. Moreover, any number of object or obstacle profiles may be predefined in a profile template library stored in a memory of the INAD 100 or a second computing device with which it is paired.

Referring back now to FIG. 1, in some embodiments INAD 100 may include one or more feedback components (e.g., feedback components 120-138) capable of providing audible, visible, or haptic feedback to a user. For example, feedback components may include one or more of a speaker, eccentric rotating mass vibration motor, linear resonant actuator, solenoid, or any other devices capable of providing audible, visible, or haptic feedback device. As shown, in some embodiments feedback components may be fixed to a portion of the INAD 100 (e.g., a speaker 120 coupled with walking staff 102, an array of vibration motors embedded within handle 104 of walking staff 102). In other embodiments, feedback components may not be affixed to INAD 100, but instead may be detached (e.g., coupled via a wireless communications link).

Feedback components (e.g., feedback components 120-138) may convey information to the user by stimulating one or more of the users sensory receptors (e.g., audible feedback via generating sound to stimulate a user's ears; visual feedback via light to stimulate a user's eyes, haptic feedback via force/pressure/vibrations to stimulate nerves in the user's skin). This information may include or be based on information generated by, received from, transmitted to, computed by, or otherwise accessible via any one or more components of INDA 100. Before discussing examples of how the feedback components of the present disclosure may be implemented in some embodiments to assist a user in navigating their course of travel or for summoning a third party for assistance, it is useful here to discuss the various types of information and resources available to the INDA 100 as a result of being paired with a second computing device such as a mobile phone.

As noted, embodiments of the INDA 100 include a local computing device (e.g., local computing device 150). Local computing device 150 may generate or obtain information from any component it is communicatively coupled with—whether the component is fixed to or detached from the INDA 100 structure. In some embodiments, local computing device 150 includes machine readable instructions stored on non-transitory computer readable medium 155 which, when executed by the processing engine 152, cause one or more signals to be transmitted (via the communications interface 153) to a mobile computing device (sometimes referred to herein as a “second computing device”) that cause the mobile computing device to perform a function, execute an operation, collect or gather information, provide information back to the INAD 100 (received via the communications interface 153) for further processing and use, or any combination of the foregoing. In short, the communications interface 153 of the INAD may facilitate communication with the resources of a second computing device (e.g., a mobile phone), and thereby obtain information provided by such resources.

The one or more resources accessed by the first computing device 150 may include any internal resources or external resources included in or accessible to the second computing device. Such resources may include, for example, GPS components and programs (e.g., GPS modules), operating systems (e.g., iOS, Android, etc.), mapping applications (e.g., a route mapping application such as Google Maps, Apple Maps, a custom route mapping application, etc.), panic applications (e.g., Red Panic Button, Bull Horns Panic Button, a custom panic application, etc.), telephony network components and programs (e.g., cellular communications components such as RF modules/chipsets and related circuitry, phone applications, SMS messaging applications, internet applications, email applications, Wi-Fi modules, etc.), scheduling applications (e.g. calendar applications), voice recognition features (e.g., iOS Siri) or any other resource native on, loadable to, or accessible from the second computing device.

The information obtained from the second computing device may include navigation information. Navigation information may include any information useful to assist a user in navigating a course of travel. For example, navigation information may include: (i) geographic location information such as current GPS coordinates or street address; (ii) direction information such as a facing direction, (ii) walking information such as instructions describing distances to walk in certain directions, when/where/how much to turn to the left, right, etc. at various points along a route; (iii) transportation information such as details about bus pick-up or drop off locations, bus or train pick-up/drop-off times, or usage instructions for use of a particular mode of transportation (e.g., an audible usage instruction that “seating on this bus is organized in rows from front to back, with preferred seating for persons with disabilities in the first row immediately to the left upon entry”, or that “you may pull a cord directly above the window nearest your seat to alert the bus driver you intend to exit at the next stop,” or any other useful information such as details about public or private transportation fares/fees, etc.); (iv) establishment information such as details about nearby restaurants, libraries, post offices, public restrooms, parks, businesses; (v) landmark information such as details about city/province borders, private property lines, residential or business district zones, historical landmarks, (vi) route information such as step-by-step or turn-by-turn instructions to get from one place to another, street names, distances to next significant change in route direction, stop light status, intersection locations, traffic conditions, road or path construction information, road or path closures, cross-walk locations, estimated times of arrival to a particular destination from a particular location, and the like. In some embodiments, the signals received from the second computing device include navigation information based in whole or in part upon data obtained from a GPS receiver, a route mapping application, or any other resource of the second computing device.

Referring back now to the feedback components of INDA 100 discussed above, in some embodiments the first computing device of INDA 100 may cause the feedback components to operate in a manner such that they convey information (such as navigation information) received by the first computing device 150 from a second computing device (e.g., a mobile phone, a tablet, etc.). For instance, the first computing device 150 may cause one or more of the feedback components to operate to stimulate one or more of the user's sensory organs in a manner that conveys navigation information.

FIG. 2B illustrates a magnified view of a handle portion of the walking staff 102 shown in FIG. 1, in accordance with one or more embodiments of the present disclosure, including a symbolic depiction of various feedback components. As shown, example feedback components that may operate in one or more embodiments of the present disclosure may include vibration motors 132, 134, 136, 138 to provide feedback (i.e., convey information) via haptic vibrations, a speaker 120 to provide feedback via audible sounds, or any other number or type of feedback component. As shown, the feedback components in some embodiments may comprise multiple vibration motors 132, 134, 136, 138 physically coupled with a handle of the walking staff at different locations (vibration motor 132 on a substantially opposite side of the handle than vibration motor 134, vibration motor 136 on a substantially opposite side of the handle than vibration motor 138).

In some embodiments, individual ones of the vibration motors may be associated with one or more relative directions such that the INAD 100 may provide movement directives (e.g., left, right, slightly left, etc.) to a user. For example, in some embodiments the processor is configured by machine readable instructions to selectively activate one or more vibration motors to provide haptic stimuli to a user's hand, the haptic stimuli corresponding to a movement directive a user may follow to align themselves with the path defined by route information received from the route mapping application of the second computing device. The haptic stimuli movement directives may be based upon the direction the user is moving or has moved most recently (e.g., taken as the facing direction based upon information gleaned from an accelerometer or GPS coupled with the INAD 100), or based on a comparison of a pointing direction of the INAD 100 and a route of travel the user is or will be proceeding upon (e.g., the pointing direction determined by an compass component coupled with the INAD 100 and associated with a forward facing portion of the INAD 100).

As noted, any type or number of feedback components may be used with INADs of the present disclosure, and any predefined patterns may be associated with any direction or directive. For example, vibration motor 132 may be associated with a directive to turn to the left 45 degrees, vibration motor 134 may be associated with a directive to turn to the right 45 degrees, vibration motor 136 may be associated with a directive to turn to the left 90 degrees, and vibration motor 138 may be associated with a directive to turn to the right 90 degrees.

In some embodiments, individual ones of the vibration motors may be associated with one or more with geographic direction (e.g., north, south, northwest, southeast) in which the INAD 100 is facing. For example, vibration motor 132 may be associated with a notification that INAD 100 is pointing north, vibration motor 134 may be associated with a notification that INAD 100 is pointing east, vibration motor 136 may be associated with a notification that INAD 100 is pointing south, and vibration motor 138 may be associated with a notification that INAD 100 is pointing west. Thus, a disoriented user may initiate a reorientation mode wherein the user may rotate in place with the INDA 100, and as the INDA faces (or points in) north, vibration motor 132 will be triggered such that the user may know what direction they are facing. Likewise with vibration 134, 136, and 138 when the user faces east, south, and west respectively. Again, any configuration of feedback components or preset designations of direction may be used in the INADs of the present disclosure

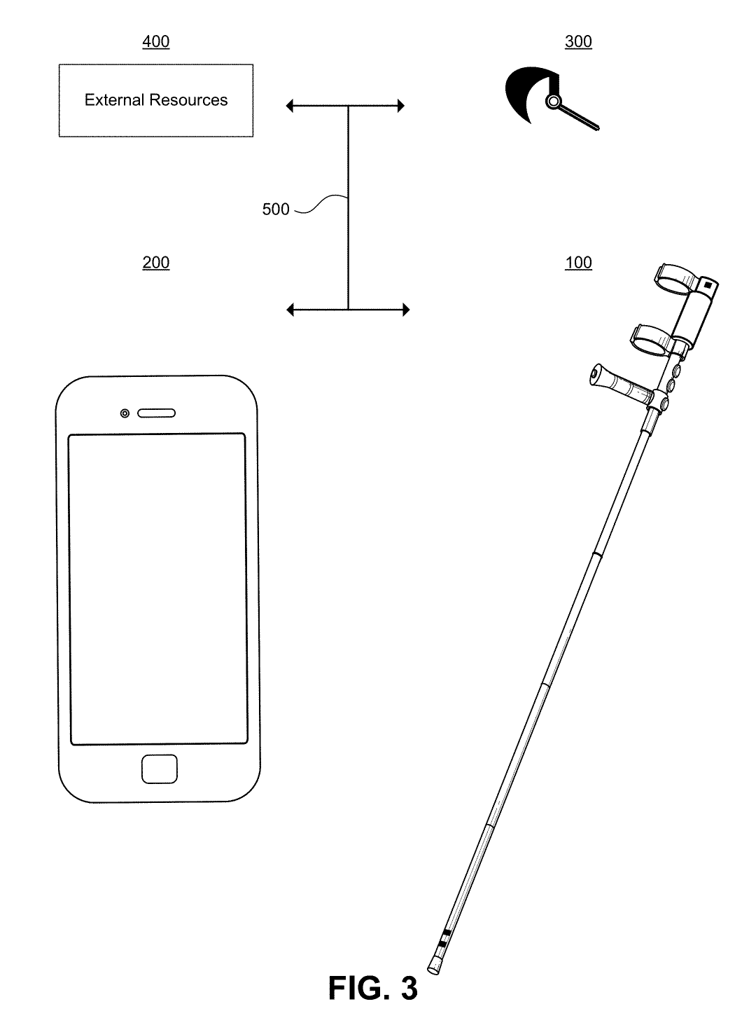

In some embodiments, one or more of the feedback components may be used to provide navigation information to a user via one or more prompts provided in the form of audible instructions. As shown in FIGS. 2A and 3, the feedback components in some embodiments may comprise a speaker coupled with the INAD 100 (e.g., speaker 120 of walking staff 102, speaker of wireless headset 300). The first computing device 150 may cause audible sounds to be emitted through a speaker coupled thereto that relays navigation information to the user. In some embodiments the audible sounds may correspond to a movement directive that, if followed, may enable a user to align themselves with the path defined by the route information received from the route mapping application of the second computing device.

In some embodiments the feedback components may include those that are coupled with the INAD 100 operatively, but which are detached physically (e.g., a speaker within a Bluetooth enabled headset that is communicatively coupled with INAD 100 via communications interface 153, a vibration motor within a smartwatch that is communicatively coupled with INAD 100 via communications interface 153). It will be appreciated that the feedback components of the present disclosure may be configured to be in direct operative communication with the INAD 100 itself (via communications interface 153), or in indirect communication with the INAD 100 via a communications interface of the second computing device providing information to or receiving information from the communications interface 153 of the INAD 100, depending on the arrangement and/or priorities desired.

Referring back now to FIG. 1, as shown with reference to INAD 100, some embodiments of the present disclosure may include one or more panic sensor components 170. Such panic sensor components 170 may include one or more sensors (e.g., gyroscopes, accelerometers, etc.) and circuitry configured to detect one or more conditions indicative of a situation or event calling for third party assistance.

For example, panic sensor components 170 in some embodiments of the present disclosure include a trip-and-fall circuit. A trip and fall circuit may include one or more sensors (e.g., a gyroscope, an accelerometer, etc.) and a timer, that together detect when one or more criteria have been met indicating the user has fallen and cannot get up (or has not gotten up) such that an automatic panic alert should be sent.

For example, the trip-and-fall circuit may include an accelerometer coupled with a timer (e.g., a timer circuit), the trip-and-fall circuit configured to detect when a user has fallen and cannot get up (or has not gotten up). For instance, when a user trips or falls, the accelerometer may detect a rate of change of velocity of the INAD 100 that is characteristic of a fall (e.g., a rate of change of velocity significantly greater than that generated by a user beginning to walk/jog/run from a standstill, or generated by a user coming to a sudden stop from walk/jog/run pace). Upon a predetermined period of time period passing (e.g., 5 minutes, as measured by the timer circuit) with little-to-no further movement detected by the accelerometer, the intelligent walking staff of the present disclosure may cause a panic alert to be sent.

In another example, the trip-and-fall circuit may include a gyroscope coupled with a timer (e.g., a timer circuit), the trip-and-fall circuit configured to detect when a user has fallen and cannot get up (or has not gotten up). For instance, when a user trips or falls, the gyroscope may detect a change in rotation of a member of INAD 100 indicating the user has fallen (e.g., the walking staff 102 is oriented such that its longitudinal axis is substantially horizontal relative to the earth, or, oriented such that the longitudinal axis makes an angle with the earth's surface that is substantially less than the angle traditionally made when the walking staff 102 is in use (e.g., substantially less than 45 degrees)). Upon a predetermined period of time period passing (e.g., 3 minutes, as measured by the timer circuit) with little-to-no further change in orientation detected by the gyroscope, the walking staff 102 of the present disclosure may cause a panic alert to be sent.

A panic alert can be any type of message or signal intended to put another party on notice that the user is in need of assistance. For instance, panic alert may involve a SMS message to a loved one notifying them of the detected fall, an signal or message to a private emergency dispatch center (e.g., Life Alert® center), a phone call to a public emergency response unit (e.g., 9-1-1 call to a police station), an audible sound emitted from the INAD 100 or a mobile device to which it is paired (e.g., the words “Please Help!” emitted from a speaker couple with the intelligent walking staff), a visible light emitted from the intelligent walking staff or a mobile device to which it is paired (e.g., flashing light emitted from an LED coupled with the walking staff 102 of FIG. 1), or any other message or signal directed to or intended to be received by a third party. In some instances, the message or signal may include details about the user's identity (e.g., based on information encoded in the memory of the mobile device to which the intelligent walking stick is paired, for example, or based on information encoded in the memory of the walking stick itself), location (e.g., based on information from a GPS of an operatively coupled mobile device), or biometrics (e.g., recently measured heart rate, etc.).

As shown in FIGS. 1 and 3, some embodiments of the INAD 100 may also include one or more LEDs (e.g., LED 130, LED 131, LED 132). Such LEDs may be operable for a variety of reasons, one of which may be to emit light as a panic alert. A panic alert may be generated automatically (e.g., via a trip-and-fall circuit, as explained above), or manually (e.g., by actuating an input component that has been preset to trigger a panic alert when actuated). For example, if a user falls and is unable to get up, or otherwise finds themselves in a situation where they need help, they may press one or more of input components 110, 112, 114, 116 (or other input component or combination thereof), to generate a panic alert. In such an instance, for example, the first computing device of INAD 100 may cause one or more of the LEDs to become illuminated, flash on and off, blink with a variety of colors, or emit any other predetermined display of light which may signify to others in the vicinity that the user needs help. The LEDs may also be useful to aid emergency responders (e.g., family members, ambulance, private responders, etc.) in finding the user who has fallen, become injured, or otherwise needs assistance. Such LEDs can be especially useful for responders looking for injured persons in environments with limited light (e.g., at nighttime). Responders can look, for example, for flashing lights of a particular color, for instance, to find the person they are looking for in a particular vicinity.

In some instances the panic alert signal(s) or message(s) may intensify or change with increased time elapsed since the initial panic alert was triggered. By way of a nonlimiting example, once a panic alert has been triggered (e.g., let this time be t=0:00) the INAD 100 may be configured to cause one or more of its LEDs to flash red light at a rate of 1 flash per second for 3 minutes. After 3 minutes have elapsed (t=3:00) with no relevant change in user status, the INAD 100 may cause the LEDs to flash red at the higher rate of 2 flashes per second, and with greater brightness, for 3 more minutes. After 3 more minutes have elapsed (t=6:00) with no relevant change in user status, an audible alert stating the word “Please Help!” may be emitted from a speaker coupled with INAD 100 at a rate of 10 recitations per minute. The sound emissions may be in addition to or in place of the LED light emissions. After 2 more minutes have elapsed (t=8:00) with no relevant change in user status, the INAD 100 may cause a signal to be generated that causes the mobile device with which the INAD 100 is coupled to transmit an SMS message to one or more emergency responders (e.g., a family member, a group of family members, an emergency responder dispatch operator, etc.) notifying them of the user's condition. The SMS message may be preconfigured with particular information and text, e.g., “This is an automated message generated by Frank's intelligent walking staff. Frank may need assistance as his walking staff is currently in an unusual position and has been for more than 8 minutes. Frank's location is 163 Main street (link). If you'd like to send Frank a notification you are on your way, please reply ‘ON MY WAY’ and an audible message will be relayed to Frank through his intelligent walking staff.” Alternatively, the user may send a custom SMS message using a voice recognition feature of the INAD 100.

It should be understood that the foregoing examples are not intended to be limiting. One of ordinary skill in the art will appreciate that embodiments of the intelligent navigation assistance devices of the present disclosure may be implemented using variations and modifications to the panic sensor components 170 (e.g., modifications to the trip-and-fall circuits described above), to the panic alert intensification/enhancement schemes, or to any components or processes involved in causing or generating a panic alert.

Moreover, as shown with reference to INAD 100 depicted in FIG. 1, some embodiments of the present disclosure may include one or more visibility sensor components 170. Such visibility sensor components 170 may include one or more sensors (e.g., photodetectors, gyroscopes, accelerometers, etc.) and circuitry configured to detect low lighting in the surrounding environment. For example, in some embodiments the INAD 100 of the present disclosure, visibility sensor components 170 may include a visibility circuit configured to detect low lighting in the surrounding environment and, together with the first computing device of the INAD 100, responsively cause an LED of the INAD 100 to emit light to alert other people of the user's presence in the viscinity. Thus, in some embodiments, LEDs of the INAD 100 of the present disclosure may also be utilized in non-emergency/non-panic type situations; for example, as a preventative safety measure.

For instance, in some embodiments the visibility circuit may include a photo-detector that detects light in the surrounding environment. When the detected light falls beneath a preset level (such that the current flow in the circuit drops beneath a predetermined threshold), the first computing device of the INAD 100 or the present disclosure may responsively cause an LED to emit light (e.g., flashing light) to alert other people in the vicinity of the user's presence. Such safety measures may help avoid accidents in areas that are dimly lit or where visibility is otherwise limited (e.g., a dimly lit parking structure, a crosswalk at nighttime, etc.).

FIG. 3 illustrates an environment within which an INAD of the present disclosure may operate, in accordance with one or more embodiments. As shown, INAD 100, mobile computing device 200, detached feedback device 300, and/or one or more external resources 400 may all be operatively coupled together. In some embodiments, any of these maybe be directly or indirectly paired with the other, directly or indirectly access or control the resources of the other, and or make its own resources directly or indirectly accessible or controllable by the other. Indirect pairing, access, or control by one or more of the foregoing merely indicates that in some instances the foregoing elements may be arranged such that a first element controls a second element by issuing a request or making a command to a third element. For example, both a mobile computing device 200 and a detached feedback device 300 (such as the Bluetooth headset shown) may be directly paired with the INAD 100, but not directly paired with each other. Yet the mobile computing device can control, access, and/or be accessible to the detached feedback device 300 by communicating with it indirectly by sending signals to the INAD 100 which may in turn relay the signals (with or without further processing) to the detached feedback device.

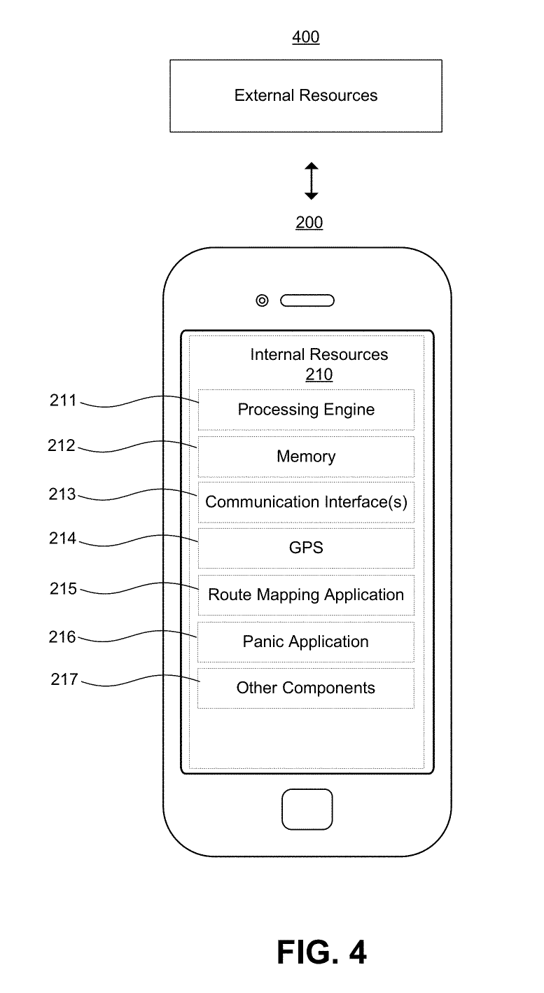

FIG. 4 illustrates a mobile computing device including or having access to one or more internal resources 210 or external resources 400 that may be utilized by an INAD of the present disclosure, in accordance with one or more embodiments. As shown, mobile computing device 200 may include internal resources 210 such as, by way of non-limiting examples, a processing engine 211, a memory 212, and one or more communication interfaces (e.g., RF Communications Interface(s), Bluetooth Interface(s), Wi-Fi Interfaces, etc.), a Global Positioning System 214 including associated components and circuitry, Route Mapping Application 215 (which in some instances may operate based on inputs provided via one or more other resources, such as GPS 214 and/or user inputs provided over communications interface(s) 213), Panic Application (which in some instances may cause the operation of another resource, such as a communications interface 213 when dialing out or sending a text message based on a command issued from an INAD), and/or any other components native to or that may be downloaded to a mobile computing device. By way of non-limiting example, external resources 400 may include any remote resources that include information associated with one or more internal resources. For instance, an external resource may be an external server providing regular road condition updates to a Route Mapping Application downloaded on the mobile computing device. In another example, an external resource may be the GPS satellites broadcasting the microwave signals received by the GPS 214 receiver of the mobile computing device 200.

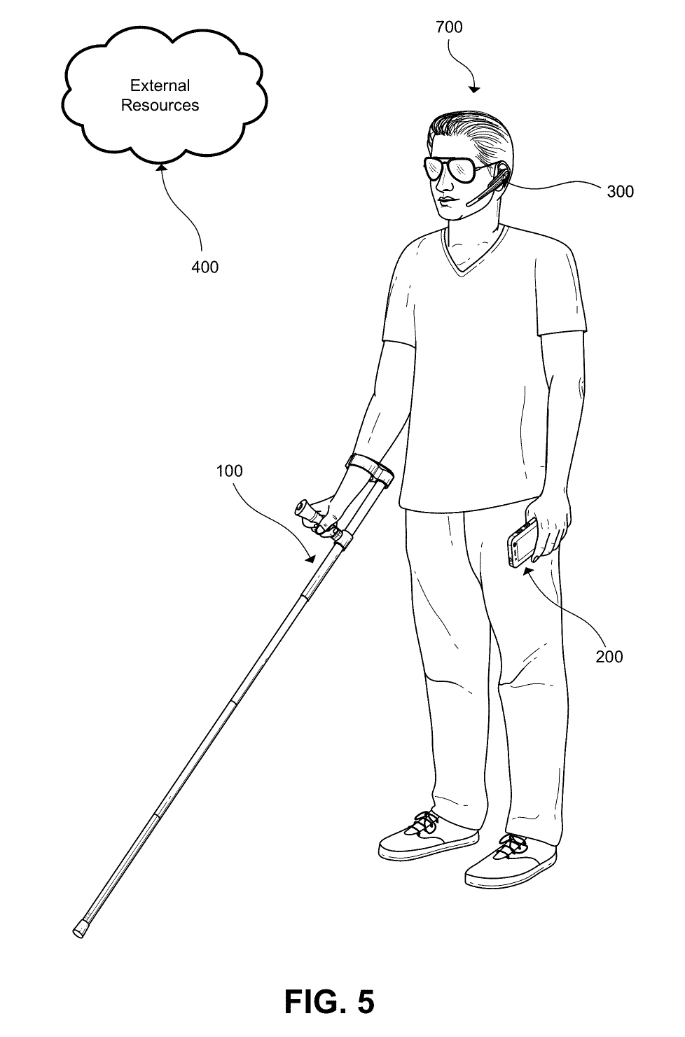

FIG. 5 illustrates a visually impaired person using an example INAD 100 in accordance with one or more embodiments of the present disclosure. As shown, a user 700 may clutch a handle portion of the walking staff 102 to control the pointing direction of the walking staff 102. INAD 100 may be wirelessly coupled, directly or indirectly, with a mobile computing device 200, a detached feedback component 300 (shown here as a Bluetooth enabled wireless headset), and one or more external resources 400.

FIG. 6 illustrates another example INAD in accordance with one or more embodiments of the present disclosure. Though INADs of the present disclosure may come in various structural forms, as noted previously, the INAD 600 depicted in FIG. 6 takes the form of a walker for elderly persons (sometimes referred to herein as an intelligent walker). As shown, the INAD 600 may include one or more of a walker 602, user input components (e.g., input components 610-618), environment sensor components 660, panic sensor components 670, feedback components (e.g., feedback components 620, 630), visibility sensor components 680, LEDs (e.g., LEDs 640-645), and a local computing device 650 (sometimes referred to herein as a first computing device) including a processing engine 652, a communications interface 653, a memory 654, and a non-transitory machine readable medium 655 storing machine readable instructions that, when executed, effectuate one or more of the features discussed herein. As shown, first computing device 650 (including its sub-elements) may be coupled with any other components 657 of the INAD 600, including any one or more of the aforementioned components (e.g., input components, environment sensor components, panic sensor components, feedback components) or any other elements of INAD 600 (e.g., a power supply such as battery 651). Such coupling may be established via any wired, wireless, or hardware interface.

As may be observed, the aforementioned elements of INAD 600 correspond to the elements of INAD 100 discussed above with reference to FIGS. 1-5. It should be understood that the above discussion with respect to such elements of INAD 100 is equally applicable the corresponding elements of INAD 600.

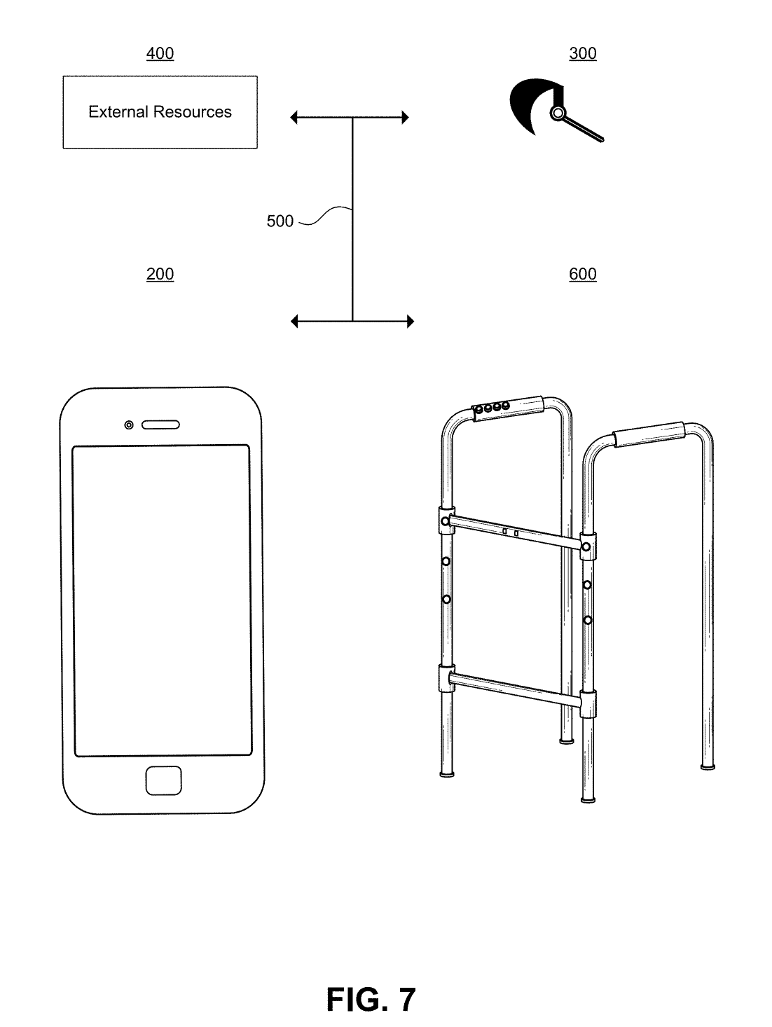

FIG. 7 illustrates an environment within which an INAD of the present disclosure may operate, in accordance with one or more embodiments. As shown, INAD 600, mobile computing device 200, detached feedback component 300, and/or one or more external resources 400 may all be operatively coupled together. In some embodiments, any of these maybe be directly or indirectly paired with the other, directly or indirectly access or control the resources of the other, and or make its own resources directly or indirectly accessible or controllable by the other. Indirect pairing, access, or control by one or more of the foregoing merely indicates that in some instances the foregoing elements may be arranged such that a first element controls a second element by issuing a request or making a command to a third element. For example, both a mobile computing device 200 and a detached feedback device 300 (such as the Bluetooth headset shown) may be directly paired with the INAD 600, but not directly paired with each other. Yet the mobile computing device can control, access, and/or be accessible to the detached feedback device 300 by communicating with it indirectly by sending signals to the INAD 600 which may in turn relay the signals (with or without further processing) to the detached feedback device.

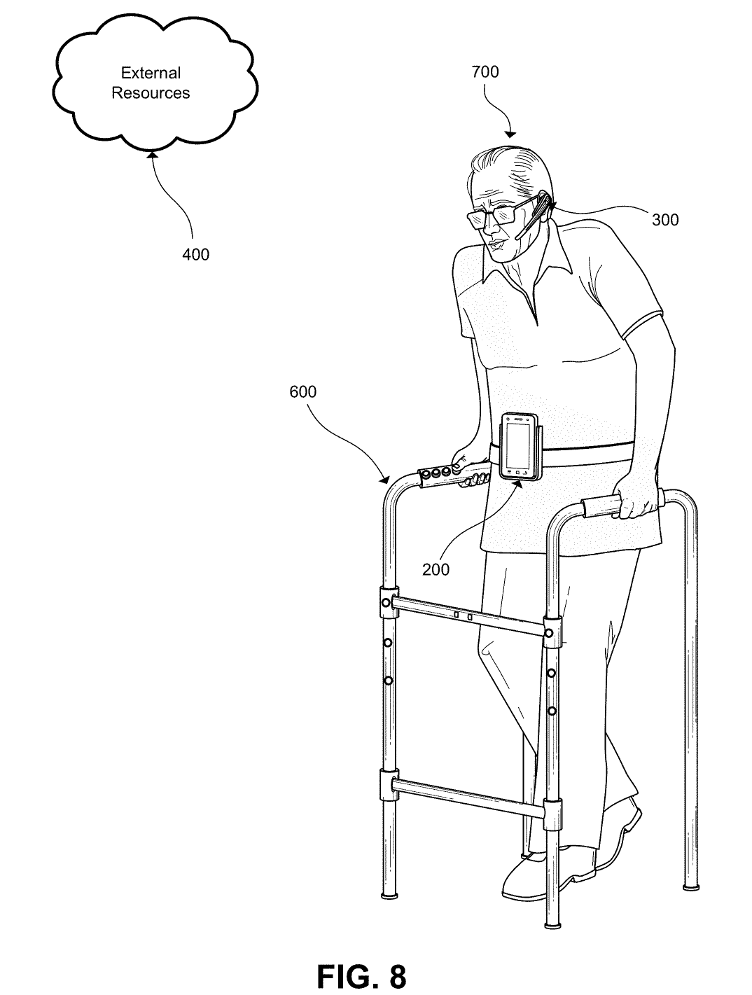

FIG. 8 illustrates an elderly person using an example INAD 600 in accordance with one or more embodiments of the present disclosure. As shown, a user 700 may clutch crossbar handle portions of the walker 602 to control the pointing direction of the walker 602. INAD 600 may be wirelessly coupled, directly or indirectly, with a mobile computing device 200, a detached feedback component 300 (shown here as a Bluetooth enabled wireless headset), and one or more external resources 400.

Some embodiments of the disclosed technology further include: a battery charging circuit (including any sensors, channels, components, or inlet/outlet interfaces commonly known in the art) to receive energy from a power source, and utilize the received energy to charge a battery of the intelligent navigation device. In some embodiments the battery charging circuit can facilitate inductive charging (e.g., receive energy from a magnetic charging source), solar charging (e.g., receive energy from the sun via a photovoltaic module), direct current charging, alternating current charging, or any other charging mechanism, including any known in the art.

Referring to FIGS. 1-8 collectively, although these illustrate example embodiments with components and circuits partitioned in the depicted manner, it will be appreciated by one of ordinary skill in the art that various components and circuits of the INADs and systems described herein may be implemented utilizing any form of hardware, software, or a combination thereof. For example, one or more processors, controllers, ASICs, PLAs, PALs, CPLDs, FPGAs, logical components, software routines or other mechanisms, including associated memory, might be used to implement one or more components or circuits in embodiments of the INADs and systems of the present disclosure. In implementation, the various components and circuits described herein might be implemented as discrete components or the functions and features described can be shared in part or in total among two or more components. In other words, as would be apparent to one of ordinary skill in the art after reading this description, the various features and functionality described herein may be implemented in any given application and can be implemented in one or more separate or shared components in various combinations and permutations. Even though various features or elements of functionality may be individually described or claimed as separate components, in various embodiments these features and functionality can be shared among one or more common software and hardware elements, and such description shall not require or imply that separate hardware or software components are used to implement such features or functionality.

INADs of the present disclosure might include, for example, one or more processors, controllers, control modules, or other processing devices (e.g., such as processing engine 152, processing engine 652, etc.). Such might be provided by general-purpose or special-purpose processing engines such as, for example, a microprocessor, controller, or other control logic. In the illustrated examples in FIGS. 1 and 6, processing engine 152, 652 is connected to bus 156, 656, respectively, although any communication medium can be used to facilitate interaction with other components of INAD 100, 600 or to communicate externally.

INADs of the present disclosure might include one or more memory modules, simply referred to herein as memory (e.g., memory 154, memory 654, etc.). For example, memory might include random access memory (RAM) or other dynamic memory which might be used for storing information and instructions to be executed by a processing engine of the INAD (e.g., by processing engine 152, by processing engine 652, etc.). Memory might also be used for storing temporary variables or other intermediate information during execution of instructions to be executed by the INAD's processing engine. Memory might likewise include a read only memory (“ROM”) or other static storage device coupled to a bus (e.g., bus 156, bus 656, etc.) for storing static information and instructions for an associated processor.

It will be understood by those skilled in the art that the INADs of the present disclosure might include one or more various forms of information storage mechanism, which might include, for example, a media drive and a storage unit interface. The media drive might include a drive or other mechanism to support fixed or removable storage media. For example, a hard disk drive, a solid state drive, a magnetic tape drive, an optical disk drive, a CD, DVD, or Blu-ray drive (R or RW), or other removable or fixed media drive might be provided. Accordingly, storage media might include, for example, a hard disk, a solid state drive, magnetic tape, cartridge, optical disk, a CD, DVD, Blu-ray or other fixed or removable medium that is read by, written to or accessed by media drive. As these examples illustrate, the storage media can include a computer usable storage medium having stored therein computer software or data.

In alternative embodiments, information storage mechanisms that may be implemented in one or more embodiments of the present disclosure might include other similar instrumentalities for allowing computer programs or other instructions or data to be loaded into one or more computing components of INADs. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to the INAD (e.g., to a memory of the INAD).

As described herein, and as one of ordinary skill in the art will appreciate, INADs of the present disclosure might include a communications interface. Such communications interfaces might be used to allow software and data to be transferred between the INADs and external devices or resources. Additional nonlimiting examples of communications interfaces might include a modem or softmodem, a network interface (such as an Ethernet, network interface card, WiMedia, IEEE 802.XX or other interface), a communications port (such as for example, a USB port, IR port, RF port, RS232 port Bluetooth° interface, or other port), or other communications interfaces. Software and data transferred via a communications interface might typically be carried on signals, which can be electronic, electromagnetic (which includes optical) or other signals capable of being exchanged by a given communications interface. These signals might be provided to the communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium,” “machine readable medium” and “computer usable medium” are used to generally refer to transitory or non-transitory media such as, for example, memory, storage unit, media, and channel discussed above. These and other various forms of computer program media, computer readable media, or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable INADs to perform features or functions of the present application as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

We claim:

1. An intelligent navigation assistance device, comprising:
a walking staff;
a processor;
a memory;
a communications interface;
an input component to receive user input;
a feedback component to provide feedback;
a non-transitory computer readable medium storing machine readable instructions that, when executed by the processor, cause the intelligent navigation assistance device to:
transmit a signal to a mobile computing device responsive to user input, the transmitted signal controlling an operation of a resource of the mobile computing device, the resource including one or more of a GPS receiver and a route mapping application;
receive a signal from the mobile computing device, the received signal providing navigation information based on information obtained from one or more of the GPS receiver and the route mapping application; and
cause a feedback component to provide one or more prompts to a user based on the navigation information received from the mobile computing device.

2. The intelligent navigation assistance device of claim 1, further comprising:
an environment component to detect the presence of physical objects in a surrounding environment, the environment component comprising one or more of an infrared sensor and a ultrasonic sensor; and
wherein the non-transitory computer readable medium stores machine readable instructions that, when executed by the processor, causes the intelligent navigation assistance device to:
cause a feedback component to provide one or more prompts to a user based on the environment component detecting a physical object in the surrounding environment.

3. The intelligent navigation assistance device of claim 2, further comprising:
a panic component to detect a condition indicating the user has fallen, the panic component comprising one or more of an accelerometer and a gyroscope;
wherein the non-transitory computer readable medium stores machine readable instructions that, when executed by the processor, causes the intelligent navigation assistance device to:
generate a panic alert responsive to the panic component detecting a condition indicating the user has fallen.

4. The intelligent navigation assistance device of claim 2, further comprising:
an panic component to detect a condition indicating the user has fallen, the panic component comprising a timer circuit and one or more of an accelerometer and a gyroscope;
wherein the non-transitory computer readable medium stores machine readable instructions that, when executed by the processor, causes the intelligent navigation assistance device to:
generate a panic alert responsive to the panic component detecting that a predetermined amount of time has elapsed after a condition indicating the user has fallen was detected.

5. The intelligent navigation assistance device of claim 1, wherein the communications interface comprises one or more of an wireless transmitter and a wireless receiver.

6. The intelligent navigation assistance device of claim 1, wherein the navigation information comprises one or more of geographic location information, route information, walking information, direction information, transportation information, and establishment information.

7. The intelligent navigation assistance device of claim 1, wherein the input component comprises one or more of a push button, a capacitive touch sensor, a microphone, and a throw switch.

8. The intelligent navigation assistance device of claim 1, wherein the one or more signals transmitted to the mobile computing device are generated responsive to actuation of the input component.

9. The intelligent navigation assistance device of claim 1, wherein the input component is a microphone configured to transduce sound.

10. The intelligent navigation assistance device claim 1, wherein the non-transitory computer readable medium stores machine readable instructions that, when executed by the processor, causes the intelligent navigation assistance device to:
determine one or more of an object type, an obstacle type, a proximity to a portion of an object, a proximity to a portion of an obstacle, a relative location of an object, and a relative location of an obstacle.

11. An intelligent navigation assistance device, comprising:
a walker;
a processor;
a memory;
a communications interface;
an input component to receive user input;
a feedback component to provide feedback;
a non-transitory computer readable medium storing machine readable instructions that, when executed by the processor, cause the intelligent navigation assistance device to:
transmit a signal to a mobile computing device responsive to user input, the transmitted signal controlling an operation of a resource of the mobile computing device, the resource including one or more of a GPS receiver and a route mapping application;
receive a signal from the mobile computing device, the received signal providing navigation information based on information obtained from one or more of the GPS receiver and the route mapping application; and
cause a feedback component to provide one or more prompts to a user based on the navigation information received from the mobile computing device.

12. The intelligent navigation assistance device of claim 11, further comprising:
an environment component to detect the presence of physical objects in a surrounding environment, the environment component comprising one or more of an infrared sensor and a ultrasonic sensor; and
wherein the non-transitory computer readable medium stores machine readable instructions that, when executed by the processor, causes the intelligent navigation assistance device to:
cause a feedback component to provide one or more prompts to a user based on the environment component detecting a physical object in the surrounding environment.

13. The intelligent navigation assistance device of claim 12, further comprising:
a panic component to detect a condition indicating the user has fallen, the panic component comprising one or more of an accelerometer and a gyroscope;
wherein the non-transitory computer readable medium stores machine readable instructions that, when executed by the processor, causes the intelligent navigation assistance device to:
generate a panic alert responsive to the panic component detecting a condition indicating the user has fallen.

14. The intelligent navigation assistance device of claim 12, further comprising:
an panic component to detect a condition indicating the user has fallen, the panic component comprising a timer circuit and one or more of an accelerometer and a gyroscope;
wherein the non-transitory computer readable medium stores machine readable instructions that, when executed by the processor, causes the intelligent navigation assistance device to:
generate a panic alert responsive to the panic component detecting that a predetermined amount of time has elapsed after a condition indicating the user has fallen was detected.

15. The intelligent navigation assistance device of claim 11, wherein the communications interface comprises one or more of an wireless transmitter and a wireless receiver.

16. The intelligent navigation assistance device of claim 11, wherein the navigation information comprises one or more of geographic location information, route information, walking information, direction information, transportation information, and establishment information.

17. The intelligent navigation assistance device of claim 11, wherein the input component comprises one or more of a push button, a capacitive touch sensor, a microphone, and a throw switch.

18. The intelligent navigation assistance device of claim 11, wherein the one or more signals transmitted to the mobile computing device are generated responsive to actuation of the input component.

19. The intelligent navigation assistance device of claim 11, wherein the input component is a microphone configured to transduce sound.

20. The intelligent navigation assistance device claim 11, wherein the non-transitory computer readable medium stores machine readable instructions that, when executed by the processor, causes the intelligent navigation assistance device to:
determine one or more of an object type, an obstacle type, a proximity to a portion of an object, a proximity to a portion of an obstacle, a relative location of an object, and a relative location of an obstacle.
